(19) United States
(12) Patent Application Publication
(10) Pub. No.: US 2026/0149182 A1
(43) Pub. Date: May 28, 2026

(54) COUPLER, RADIO FREQUENCY NETWORK SYSTEM AND BASE STATION ANTENNA

(71) Applicant: Outdoor Wireless Networks LLC, Richardson, TX (US)

(72) Inventors: Guiyu Sun, Suzhou (CN); Fangwen Wan, Suzhou (CN); Ting Zhang, Suzhou (CN)

(21) Appl. No.: 19/393,777

(22) Filed: Nov. 19, 2025

(30) Foreign Application Priority Data
Nov. 27, 2024 (CN) 2024117105589

(51) Int. Cl. H01Q 13/08; H01Q 1/52

(52) U.S. Cl. CPC H01Q 13/08; H01Q 1/52

(57) ABSTRACT

A coupler comprises a dielectric substrate, first and second transmission lines on a first side of the dielectric substrate, and first and second coupling lines on a second side of the dielectric substrate. The first coupling line at least partially overlaps the first transmission line in a first direction that is perpendicular to a first side of the dielectric substrate, and the second coupling line at least partially overlaps the second transmission line in the first direction. The first coupling line is electrically connected to the second transmission line via one or more first conductive structures, and the second coupling line is electrically connected to the first transmission line via one or more second conductive structures.

### CROSS-REFERENCE TO RELATED APPLICATION

The present application claims priority to Chinese Patent Application No. 202411710558.9, filed Nov. 27, 2024, the entire content of which is incorporated herein by reference as if set forth fully herein.

### FIELD

The present application generally relates to radio communications, and more particularly to a coupler, a radio frequency network system, and a base station antenna, such as a multi-beam antenna.

### BACKGROUND

Cellular communication systems are well known in this field. In a typical cellular communication system, a geographic area is divided into a series of regions that are referred to as “cells”, and each cell is served by base stations. The base station may comprise baseband equipment, a radio transceiver device, and a base station antenna, which is configured to provide two-way radio frequency (“RF”) communication for subscribers positioned throughout the cell. In many cases, the cell may be divided into a plurality of “sectors” in the azimuth plane, and separate base station antennas provide coverage for each sector. Base station antennas are often mounted on towers or other raised structures, and radiation beams generated by each antenna (“antenna beams”) are directed outwardly from the antenna to service respective sectors. Usually, the base station antenna comprises one or more phased arrays of radiating elements, and when the antenna is installed and used, the radiating elements are arranged in one or more vertical columns. “Vertical” herein refers to a direction perpendicular to a plane defined by a horizon.

A common base station configuration is a “three-sector” configuration, where the cell is divided into three 120° sectors in the azimuth plane, and the base station can comprise at least three base station antennas that provide coverage for the three respective sectors. The azimuth plane refers to a horizontal plane that bisects the base station antenna and is parallel to the plane defined by the horizon. In a three-sector configuration, antenna beams generated by each base station antenna typically have a half-power beam width (“HPBW”) of approximately 65° in the azimuth plane so that the antenna beams provide good coverage throughout the three 120° sectors. Typically, each base station antenna comprises a vertically-extending column of radiating elements, and the radiating elements together generate antenna beams. Each radiating element in the column may have an HPBW of approximately 65° so that antenna beams generated by the column of radiating elements will cover the 120° sectors in the azimuth plane. The base station antenna may comprise a plurality of columns of radiating elements operating in same or different frequency bands.

Most modern base station antennas also comprise phase shifter/power divider circuits that allow a cellular network operator to apply phase tapers to the sub-components of the RF signals that are fed to the radiating elements in an array. By adjusting the amount of the phase taper applied, the pointing angle of the resulting antenna beams may be charged in the vertical or “elevation” plane to a desired angle. Such technique may be used to adjust how far the antenna beams extend outwardly from the antenna and may therefore be used for adjusting a coverage area of the base station antenna.

Sector splitting refers to a technique that is used to divide a coverage area of a base station into more than three sectors in the azimuth plane, such as six, nine, or even twelve sectors. The six-sector base station will have six 60° sectors in the azimuth plane. Splitting of each 120° sector into two sub-sectors increases the system capacity as each antenna beam provides coverage of a smaller area and therefore may provide higher antenna gains. In a six-sector sector splitting application, a single multi-beam antenna may generally be used for each 120° sector. The multi-beam antenna generates two separate antenna beams, each antenna beam has a reduced dimension in the azimuth plane, and each antenna beam points in a different direction in the azimuth plane, thereby splitting the sector into two smaller sub-sectors. The antenna beams generated by the multi-beam antenna used in the six-sector configuration preferably have an azimuth HPBW value between, for example, approximately 27° and 39°, and the pointing directions of first and second sector splitting antenna beams in the azimuth plane are typically approximately - 27° and 27°, respectively, from the 0° “boresight pointing direction” of the antenna in the azimuth plane, which refers to a horizontal axis extending from the base station antenna and pointing to the center of the region (typically a 120° sector) serviced by the base station antenna in the azimuth plane.

Several methods have been used to achieve a multi-beam antenna that provides coverage for respective first and second sub-sectors of the 120° sector in the azimuth plane. In a first method, first and second columns of radiating elements are mounted on two main inner surfaces of a V-shaped reflective plate. An angle defined by an inside surface of the “V” shaped reflective plate may be approximately 54° so that the two columns of radiating elements are mechanically positioned or “turned” to point at azimuth angles (i.e., towards the middles of the respective sub-sectors) of approximately −27° and 27°, respectively. Since an azimuth HPBW of a typical radiating element is generally suitable to cover the entire 120° sector, RF lenses are mounted in front of two columns of radiating elements to reduce the azimuth HPBW of each antenna beam to an appropriate amount to provide coverage of the 60° sub-sectors. However, unfortunately, the use of RF lenses may increase the dimension, weight, and cost of the base station antenna, and the amount that the RF lenses narrow the beam width of the antenna beams in the azimuth plane is a function of frequency, thereby making it difficult to obtain suitable coverage when a broadband radiating element operating over a wide frequency range (e.g., radiating element operating over a cellular frequency range of whole 1.7-2.7 giga hertz (“GHz”)) is used.

In a second method, a multi-beam antenna may be implemented using so-called beamforming networks. Two RF signal sources (per polarization) may be coupled to a multi-column radiating element array via the beamforming network (such as a Butler matrix). The beamforming network generates two separate antenna beams based on two RF signals that are input to the beamforming network, and the antenna beams are electrically offset from the boresight pointing direction of the antenna at azimuth angles of approximately −27° and 27° to provide coverage to the two sub-sectors.

In such a multi-beam antenna, the beamforming network (which may be a Butler matrix, a Nolen matrix, a Blass matrix or various other beamforming network designs that are known in the art) plays a key role as an important component. For twin-beam sector-splitting antennas, Butler matrices are often used as the beamforming network, so the discussion below will use a Butler matrix beamforming network as an example. The Butler matrix may be used to feed sub-components of each input RF signal to the radiating elements in the multi-column array with precise power levels and phases to form antenna beams having desired shapes, beamwidths and pointing directions. The Butler matrix typically includes a plurality of couplers such as four-port couplers, and combinations and/or configurations of the couplers determine the performance of the Butler matrix, comprising, for example, properties such as beam forming capabilities, gains, and/or directionality. By reasonably designing the coupler, the Butler matrix is capable of effectively meeting the needs of the multi-beam antenna.

Four-port couplers are well-known in the art, and the four ports are typically referred to as an input port, an output port, a coupling port, and an isolation port. When an RF signal having a predetermined input power is input at the input port, a first predetermined proportion of the power is output at the output port, a second predetermined proportion of the power is output at the coupling port, and ideally no power is output at the isolation port. But in actual conditions, there is always some power output at the isolation port. It should be understood that couplers are bidirectional devices and hence in accordance with the principle of reciprocity, when an RF signal is input at the above-discussed “output port”, the “output port” is converted into the input port of the coupler, the above “input port” is converted into the output port of the coupler, the “isolation port” is converted into the coupling port of the coupler, and the above “coupling port” is converted into the isolation port of the coupler.

A coupler can be characterized by a variety of parameters, such as the coupling degree, isolation degree, directionality, and the like. When an RF signal with power P1 is input at the input port, the power output at the output port is P2, the coupling power output at the coupling port is P3, and the leakage power output at the isolation port is P4. The “coupling degree” of the coupler may be expressed as the ratio of the coupling power P3 to the input power P1. The “isolation degree” of the coupler may be expressed as the ratio of the leakage power P4 to the input power P1. The “directionality” of the coupler may be expressed as the ratio of the coupling power P3 to the leakage power P4. The directionality is a metric or quality factor of the coupler's ability to discriminate between incident and reflected waves.

In a multi-beam antenna (e.g., a twin-beam antenna) application, there are sometimes strict requirements for the coupling degree and/or directionality of the coupler, for example, it is desirable to provide a coupler with a strong coupling degree (i.e., output a higher amount of power via the coupling end), such as a coupling degree of −3 dB. In addition, a coupler compact in dimension and/or simple in structure is also worth pursuing in the multi-beam antenna application scene.

### SUMMARY

Therefore, an objective of the present application is to provide a coupler, a radio frequency network system and a base station antenna capable of overcoming at least one drawback in the prior art.

According to a first aspect of the present application, a coupler is provided, comprising: a dielectric substrate; a first transmission line and a second transmission line on a first side of the dielectric substrate, a first coupling line and a second coupling line on a second side of the dielectric substrate, wherein the first coupling line and the first transmission line are at least partially overlap with each other in a first direction that is perpendicular to a first side of the dielectric substrate, and the second coupling line and the second transmission line at least partially overlap with each other in the first direction, wherein the first coupling line is electrically connected to the second transmission line via one or more first conductive structures, and the second coupling line is electrically connected to the first transmission line via one or more second conductive structures.

According to a second aspect of the present application, a radio frequency network system is provided, the radio frequency network system is formed as a feed network system for an antenna, the feed network system is configured to couple RF signals from a radio transceiver device to a radiating element array, wherein the feed network system comprises a coupler and a power divider, wherein at least one coupler of the feed network system is formed as the coupler according to some examples of the present application.

According to a third aspect of the present application, a base station antenna is provided, the base station antenna comprising: a reflective plate; an radiating element array mounted on a front side of the reflective plate; and a radio frequency network system mounted on a rear side of the reflective plate, the radio frequency network system being formed as the radio frequency network system according to some examples of the present application.

### BRIEF DESCRIPTION OF THE DRAWING

FIG. 1 is a schematic block diagram of a multi-beam antenna.

FIG. 2 is a schematic front view of an exemplary multi-column radiating element array of a multi-beam antenna.

FIG. 3 is a schematic block diagram of a multi-beam antenna along with a radio transceiver device.

FIG. 4 is a schematic block diagram of a feed network system that includes a beamforming network.

FIG. 5 and FIG. 6 show exemplary circuit diagrams of a feed network unit, respectively.

FIG. 7 is a schematic front view of an exemplary radiating element array of a multi-beam antenna.

FIG. 8 is an exemplary circuit diagram of a feed network unit having a coupler according to some examples of the present application.

FIG. 9 is an enlarged schematic front view of a portion of the coupler in FIG. 8, with an isolation area on a rear side being additionally shown.

FIG. 10 is a schematic cross-sectional view of the coupler in FIG. 8.

FIG. 11 is a schematic rear view of the coupler in FIG. 8, with a coupling line within the isolation area being additionally shown.

FIG. 12 is a simplified perspective view of a multi-beam antenna according to some example embodiments of the present invention viewed from behind.

FIG. 13 and FIG. 14 are exemplary circuit diagrams of feed network units having a coupler according to some example embodiments of the present invention, respectively.

### DETAILED DESCRIPTION

The present application will be described below with reference to the attached drawings, wherein the attached drawings illustrate certain examples of the present application. However, it should be understood that the present application may be presented in many different ways and is not limited to the examples described below; in fact, the examples described below are intended to make the disclosure of the present application more complete and to fully explain the protection scope of the present application to those skilled in the art. It should also be understood that the examples disclosed in the present disclosure may be combined in various ways so as to provide more additional examples.

In various examples of different descriptions, same reference numerals or same element names are configured for same elements, wherein the disclosures contained in the full text of the Specification can be transferred to elements having same reference numerals or same element names as intended. Further, in various examples, the number of elements, implementations, and/or arrangement structures are not limited to the illustrated examples, but are capable of selecting other quantities, implementations, and/or arrangement structures according to actual needs.

As used herein, spatial relational terms such as “above,” “below,” “left,” “right,” “front,” “back,” “high,” “low,” and the like are used to describe the relationship of one feature to another feature in the attached drawings. It should be understood that spatial relational terms, in addition to the orientations shown in the attached drawings, also encompass different orientations of the apparatus during use or operation. For example, when the apparatus is flipped in the attached drawings, a feature previously described as “below” another feature may now be described as “above” that other feature. The apparatus may also be oriented in other ways (rotated 90 degrees or in other orientations), and the relative spatial relationships will be interpreted accordingly in those cases.

As used herein, the term “A or B” comprises “A and B” and “A or B”, not exclusively “A” or “B”, unless otherwise specified.

As used herein, the terms “illustrative” or “exemplary” mean “serving as an example, instance, or illustration,” rather than as a “model” to be precisely replicated. Any realization method described exemplarily herein is not necessarily interpreted as being preferable or advantageous over other realization methods. Furthermore, the present application is not limited by any expressed or implied theory given in the above technical field, background art, summary of the invention or embodiments.

As used herein, the term “substantially” means encompassing slight variations resulting from design or manufacturing defects, tolerances of components or elements, environmental influences, and/or other factors.

As used herein, the term “part” may be a part of any proportion. For example, it may be larger than 10%, 20%, 30%, 40%, 50%, 60%, 70%, 80%, 90%.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

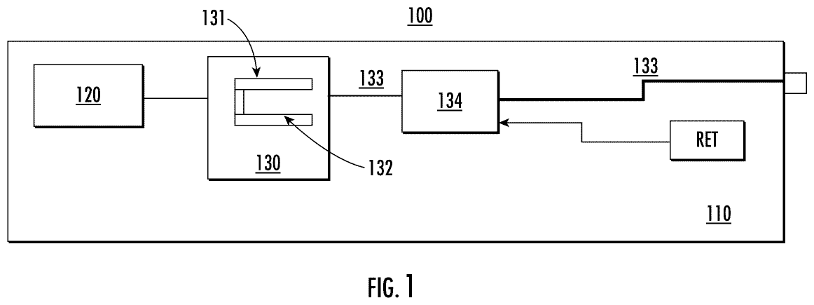

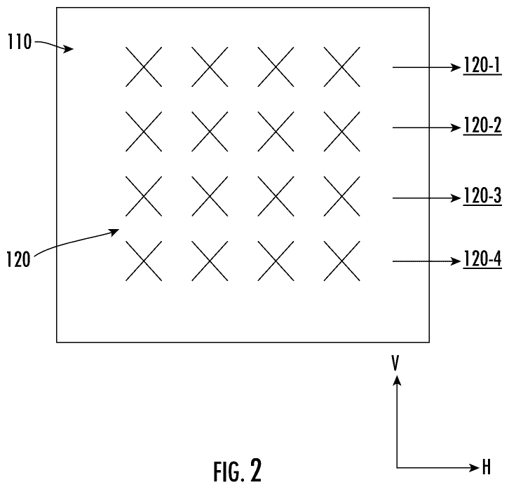

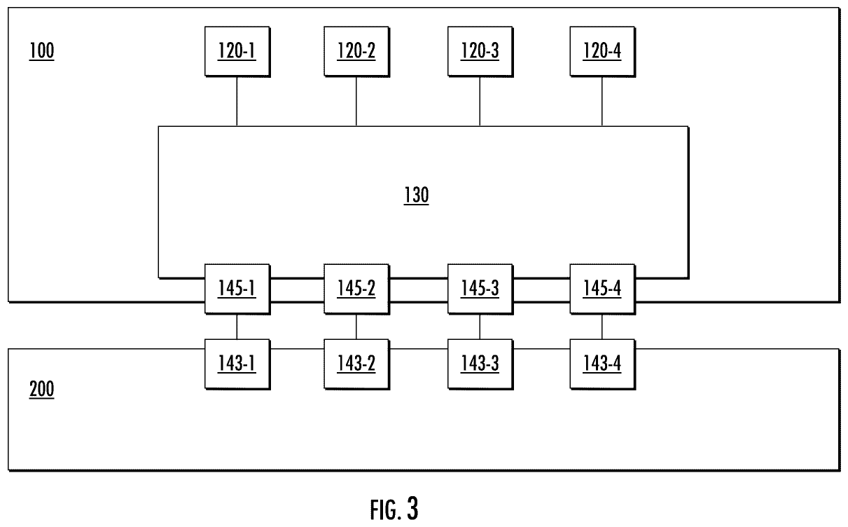

Referring to FIG. 1 to FIG. 4, a multi-beam antenna 100 is shown, wherein FIG. 1 is a schematic block diagram of the multi-beam antenna 100. FIG. 2 is a schematic front view of an exemplary multi-column radiating element array 120 of the multi-beam antenna 100. FIG. 3 is a schematic block diagram of the multi-beam antenna 100 along with the radio transceiver device 200. FIG. 4 is a schematic block diagram of a feed network system 130 of multi-beam antenna 100.

The antenna 100 usually comprises an antenna cover (not shown) such as a radome that provides environmental protection. As shown in FIG. 1 and FIG. 2, the antenna 100 may comprise a reflective plate 110. The reflective plate 110 may comprise a metal surface that provides a ground plane for the radiating elements of the multi-column radiating element array 120 and also reflects rearwardly directed electromagnetic radiation from the radiating elements back in the forward direction. The antenna 100 may also comprise additional mechanical and electronic components, such as one or more of feed network systems 130, cables 133, phase shifters 134, remote electronic tilt (RET) units, connectors, duplexers, and the like, arranged on a rear side of the reflective plate 110.

As shown in FIG. 2, the antenna 100 may also comprise a radiating element array 120 arranged on a front side of the reflective plate 110. The various radiating elements are mounted to extend forwardly from the reflective plate 110. The radiating element array 120 may comprise a plurality of columns of radiating elements (four columns exemplified in the figure), wherein each column of radiating elements may comprise a plurality of radiating elements arranged along a vertical direction V of the antenna. The four columns of radiating elements may be spaced apart from each other in a horizontal direction H. The radiating element array 120 may comprise a plurality of rows of radiating elements 120-1 to 120-4 (exemplarily shown as four rows in the figure), wherein each row of radiating elements may comprise a plurality of radiating elements arranged along the horizontal direction H of the antenna. These four rows of radiating elements 120-1 to 120-4 may be spaced apart from each other in the vertical direction V. The vertical direction V may be a direction of a longitudinal axis of the base station antenna or may be parallel to the longitudinal axis. The vertical direction V is perpendicular to the horizontal direction H and the forward direction. As used herein, the term “vertical” does not necessarily require the object to be fully vertical (e.g., the antenna may have a small mechanical downtilt).

It will be understood that the arrangement scheme for the radiating element array 120 may be diverse and not limited to the current examples. In some examples, the radiating element array 120 may have more or fewer columns of radiating elements, and/or have more or fewer rows of radiating elements. Additionally or alternatively, the numbers and/or arrangement modes of the radiating elements between different columns of radiating elements or between different rows of radiating elements may also vary in order to adapt to specific application scenes (e.g., for purposes of adapting to mounting environmental constraints and/or achieving radiation pattern adjustment).

FIG. 3 is a schematic block diagram of the multi-beam antenna 100 along with the radio transceiver device 200. The multi-beam antenna 100 may be electrically connected to the radio transceiver device 200 via an RF transmission line (such as a coaxial cable). For example, the radio transceiver device 200 may be a cellular base station radio transceiver device, and the antenna 100 and the radio transceiver device 200 may be located at the cellular base station (e.g., may be a component of the cellular base station). According to some examples, a single radio transceiver device may be coupled to an antenna. In other examples, a plurality of radio transceiver devices may be coupled to an antenna.

As shown in FIG. 3, radio frequency ports 145-1 to 145-4 of the antenna 100 may be electrically connected to ports 143-1 to 143-4 of the radio transceiver device via respective RF transmission lines (such as coaxial cables). For example, ports 145-1 and 145-3 may be first polarization ports, and ports 145-2 and 145-4 may be second polarization ports, wherein second polarization is different from first polarization (e.g., orthogonal to the first polarization). It will be appreciated that the configuration of the radiators included in the dual-polarized radiating elements of the antenna array 120 determine the polarization of the transmitted and received signals. A first polarization port refers to a port that is ultimately coupled to the first polarization radiators of the radiating elements in the antenna array 120, and a second polarization port refers to a port that is ultimately coupled to the second polarization radiators of the radiating elements in the antenna array 120.

A feed network system 130 may be provided between the RF ports 145-1 to 145-4 of the antenna 100 and the radiating element array 120. The feed network system 130 may couple a downlink RF signal (i.e., an RF signal that is to be transmitted by the antenna 100) from the radio transceiver device 200 to the radiating element array 120. The feed network system 130 may also couple an uplink RF signal from the radiating element array 120 to the radio transceiver device 200.

Each output of the feed network system 130 of the multi-beam antenna 100 may be coupled to a row of radiating elements 120-1, 120-2, 120-3, 120-4 in the radiating element array 120, respectively. In order to generate a plurality of antenna beams (here, two antenna beams) that can be separated from each other in the azimuth plane, each output of the feed network system 130 may be coupled to a row of radiating elements 120-1, 120-2, 120-3, 120-4, respectively, in the radiating element array 120. In other embodiments (not shown), in order to generate a plurality of antenna beams that can be separated from each other in the elevation plane, each output of the feed network system 130 may be coupled to a column of radiating elements in the radiating element array 120, respectively.

FIG. 4 is a schematic block diagram of a feed network system 130, and the feed network system 130 is coupled to multiple rows (such as four rows) of radiating elements 120-1 to 120-4. In other words, the four rows of radiating elements 120-1 to 120-4 may be coupled to four feed network modules of the feed network system 130, and each feed network module may comprise a first feed network unit 131 and a second feed network unit 132, respectively. The first feed network unit 131 may be configured to be used for coupling sub-components of the first polarization RF signals to a row of radiating elements 120-1, 120-2, 120-3, 120-4. The second feed network unit 132 may be configured to be used for coupling sub-components of the second polarization RF signals to a row of radiating elements 120-1, 120-2, 120-3, 120-4.

The input to the feed network system 130 may comprise a first RF signal RF1 and a second RF signal RF2. The first RF signal RF1 may be divided into, for example, four sub-components (e.g., using one or more power dividers not shown), and each sub-component may be passed to the respective first feed network unit 131 and thereby be passed to one of rows 120-1 to 120-4. Similarly, the second RF signal RF2 may be divided into four sub-components (e.g., using one or more power dividers not shown), and each sub-component may be passed to the respective first feed network unit 131 and thereby be passed to one of rows 120-1 to 120-4. The four rows 120-1 to 120-4 of radiating elements may therefore collectively generate first and second antenna beams based on the first and second RF signals RF1 and RF2, respectively. The first and second RF signals RF1 and RF2 may be fed to the feed network system 130 from the radio transceiver device. In some examples, the first and second RF signals RF1 and RF2 may be provided to the feed network system 130 via respective first polarization ports of the antenna 100, respectively.

Similarly, the input of the feed network system 130 may also comprise a third RF signal RF3 and a fourth RF signal RF4. The third RF signal RF3 may be divided into, for example, four sub-components (e.g., using one or more power dividers not shown), and each sub-component may be passed to a respective second feed network unit 132 and thereby be passed to one of rows 120-1 to 120-4. Similarly, the fourth RF signal RF4 may be divided into four sub-components (e.g., using one or more power dividers not shown), and each sub-component may be passed to the respective second feed network unit 132 and thereby be passed to a respective one of rows 120-1 to 120-4. The four rows 120-1 to 120-4 of radiating elements may therefore collectively generate a third antenna beam and a fourth antenna beam based on the third and fourth RF signals RF3 and RF4, respectively. The third and fourth RF signals RF3 and RF4 may be fed to the feed network system 130 via the radio transceiver device. In some examples, the third and fourth RF signals RF3 and RF4 may be provided to the feed network system 130 via respective second polarization ports of the antenna 100, respectively.

In some examples, the multi-beam antenna 100 (e.g., a twin-beam antenna) may have two first polarization ports 145-1 and 145-3 and two second polarization ports 145-2 and 145-4, where each port 145-1 through 145-4 is configured to receive RF signals from respective ports 143-1 to 143-4 of the radio transceiver device 200. Each RF signal may be coupled to the feed network system 130 via a respective phase shifter and power divider, thereby being coupled to the radiating element array 120 via the feed network system 130.

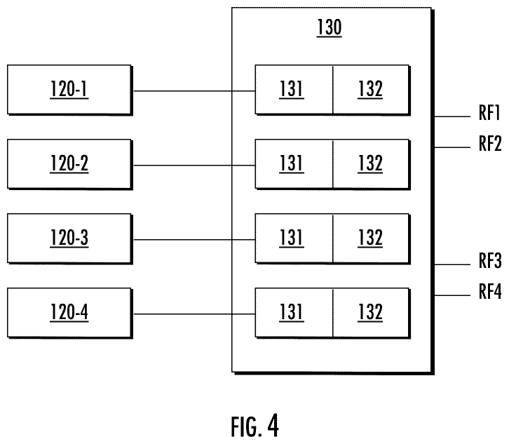

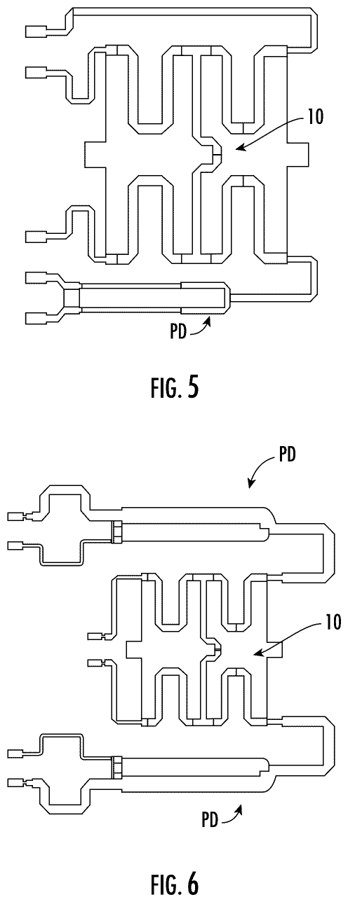

FIG. 5 and FIG. 6 are exemplary circuit diagrams of feed network units that can be used to implement the feed network units 131, 132. The feed network system 130 may be constructed based on a Butler matrix, and each feed network unit 131, 132 of the feed network system 130 may comprise a power divider PD, a coupler 10, and an RF transmission line. FIG. 5 illustrates a two-input three-output feed network unit. FIG. 6 illustrates a two-input four-output feed network unit. It will be understood that the number of outputs of the feed network units 131, 132 depends on the number of radiating elements in one row of radiating elements 120-1, 120-2, 120-3, 120-4. In some examples, as shown in FIG. 7, the radiating element array 120 may comprise rows that have different numbers of radiating elements. In the example of FIG. 7, some rows have three radiating elements while other rows have four radiating elements. A two-input three-output feed network unit as shown in FIG. 5 may be employed for each row of radiating elements, that has three radiating elements and a two-input four-output feed network unit as shown in FIG. 6 may be employed for each row of radiating elements that has four radiating elements.

As mentioned above, in a multi-beam antenna 100 application, it is sometimes desirable to provide a coupler 10 having a strong coupling degree (i.e., output a greater amount of power via the coupling end), such as a coupling degree of −3 dB. In order to achieve the coupler 10 having the strong coupling degree, the coupler 10 of the Butler matrix is typically designed as a component branch coupler as shown in FIG. 5 and FIG. 6.

However, such branch coupler is relatively difficult to design. Typically, the impedance of the branch coupler is relatively large, e.g., 110 Ω can be reached, such that simulation becomes more difficult, and multiple debugging is typically required to achieve the desired performance. This not only increases the time cost of design and development, but can also lead to instability in end product performance.

Moreover, the overall dimension of such a branch coupler is generally larger, thereby resulting in the overall dimension of the feed network units 131, 132 becoming larger. The larger dimensions may be problematic due to the limited installation space within the antenna 100. To this end, as shown in FIG. 1, the first and second feed network units 131, 132 of each feed network module may be stacked arrangement relative to each other. But the stacked arrangement also brings additional complexity. In particular, solder plates are often covered during assembly, making subsequent assembly, welding and repairing of passive intermodulation (PIM) problems difficult. This not only increases the inconvenience in production, but may also affect the reliability and maintenance efficiency of the antenna 100. Accordingly, the existing feed network units 131, 132 based on branch couplers need to be greatly improved to address at least one of the above-described issues.

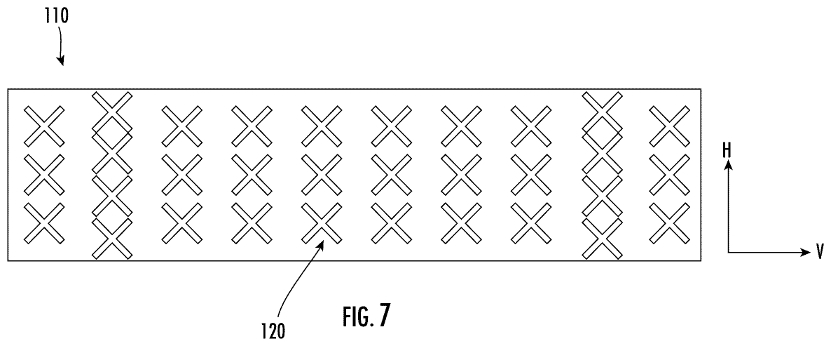

Next, the coupler 10 according to some examples of the present application is described in detail with reference to FIG. 8 to FIG. 14. The present application relates to a coupler 10 having a strong coupling degree, i.e., a coupler 10 having a strong coupling degree (i.e., output a greater amount of power via the coupling end of the coupler 10), for example a coupling degree of −3 dB. The coupler 10 provided in the present application may be designed as a parallel line coupler 10 rather than a branch coupler. The impedance of the parallel line coupler 10 may be designed, for example, to be about 50 Ω, which makes the simulation simpler, thereby not only reducing the time and cost of design and development, but also improving the stability of the end product performance.

Further, the overall dimension of the parallel line coupler 10 is generally smaller, thereby resulting in smaller overall dimensions of the feed network units 131, 132. The first and second feed network units 131, 132 of each feed network module may be arranged side by side with each other in the horizontal direction, without the need for a complex stacked arrangement. The side by side arrangement may simplify subsequent assembly, welding, and/or repair of passive intermodulation (PIM) problems. This not only increases the efficiency in the production process, but also increases the reliability and maintenance efficiency of the product.

FIG. 8 to FIG. 11 illustrate feed network units 131, 132 of the coupler 10 according to some examples of the present application. The feed network units 131, 132 may be implemented on a printed circuit board, such as a single-layer printed circuit board. Advantageously, implementing the feed network units on a single-layer printed circuit board may be cost-effective and space-saving.

Each of the feed network units 131, 132 may comprise a plurality of inputs for a plurality of sub-components of a plurality of RF signals for a plurality of antenna beams and a plurality of outputs for a row of radiating elements. Each input may be configured to receive one sub-component of one RF signal, and each output may be configured to couple to one radiating element of a row of radiating elements.

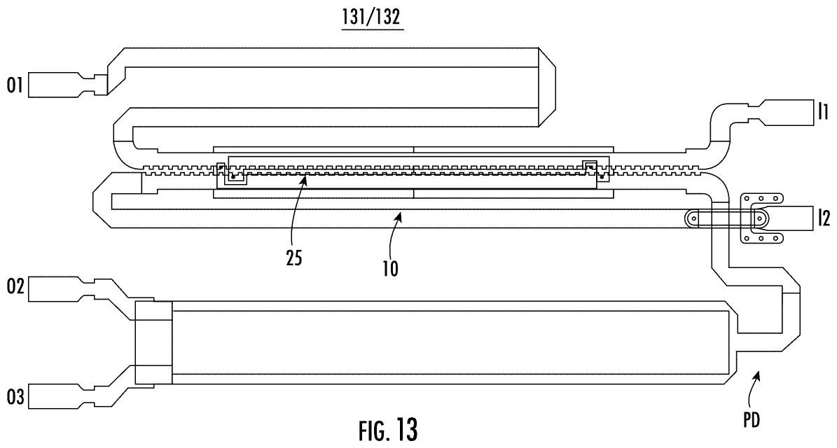

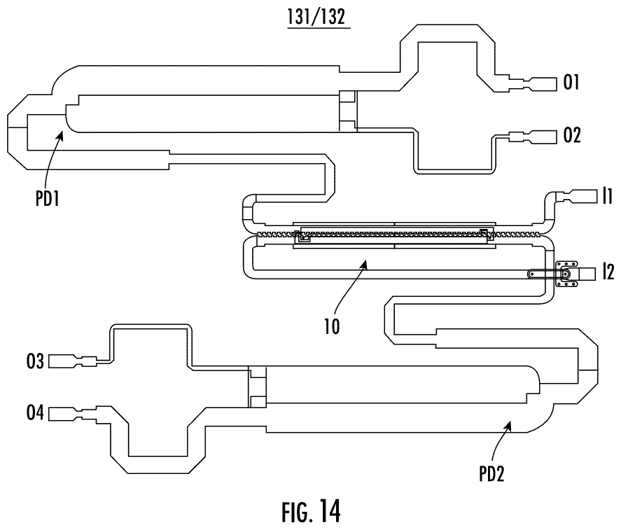

As shown in FIG. 8 and FIG. 13, the feed network units 131, 132 may be formed as a two-input three-output feed network unit, which may comprise: a first input I1 for receiving a first component of a first RF signal of a first beam and a second input I2 for receiving a first component of a first RF signal of a second beam; a coupler 10; a power divider PD; and a first output O1, a second output O2 and a third output O3. The first input I1 may be electrically connected with the first output O1 via the coupler 10, and the first input I1 is electrically connected with the second output O2 and the third output O3 via the coupler 10 and the power divider PD. The second input I2 may be electrically connected with the first output O1 via the coupler 10, and the second input I2 may be electrically connected with the second output O2 and the third output O3 via the coupler 10 and the power divider PD.

Advantageously, feed network units 131, 132 of the parallel line coupler 10 of FIG. 8 and FIG. 13 may have compact dimensions. In some examples, widths of the feed network units 131, 132 may be between 50 millimeters and 70 millimeters, and/or lengths of the feed network units 131, 132 may be between 85 millimeters and 105 millimeters. In some examples, the widths of the feed network units 131, 132 may be between 55 millimeters and 65 millimeters, and/or the lengths of the feed network units 131, 132 may be between 90 millimeters and 100 millimeters. It will be understood that the widths and/or lengths of the feed network units may be adaptively adjusted according to specific applications, such as an operating frequency band and/or a mounting environment, with the parameters being merely exemplary.

In some examples, as shown in FIG. 14, the feed network units 131, 132 may be formed as two-input four-output feed network units, which may comprise: a first input I1 for receiving a first component of a first RF signal of a first beam and a second input I2 for receiving a first component of a first RF signal of a second beam; a coupler 10; a first power divider PD1 and a second power divider PD2; and a first output O1, a second output O2, a third output O3, and a fourth output O4. The first input I1 is electrically connected with the first output O1 and the second output O2 via the coupler 10 and the first power divider PD1, and the first input I1 is electrically connected with the third output O3 and the fourth output O4 via the coupler 10 and the second power divider PD2. The second input I2 may be electrically connected with the first output O1 and the second output O2 via the coupler 10 and the first power divider PD1, and the second input I2 may be electrically connected with the third output O3 and the fourth output O4 via the coupler 10 and the second power divider PD2.

Advantageously, feed network units 131, 132 of the parallel line coupler 10 of FIG. 14 may obtain compact dimensions. In some examples, the widths of the feed network units 131, 132 may be between 85 millimeters and 105 millimeters, and/or the lengths of the feed network units 131, 132 may be between 115 millimeters and 135 millimeters. In some examples, the widths of the feed network units 131, 132 may be between 90 millimeters and 100 millimeters, and/or the lengths of the feed network units 131, 132 may be between 120 millimeters and 130 millimeters. It will be understood that the widths and/or lengths of the feed network units may be adaptively adjusted according to specific applications, such as an operating frequency band and/or a mounting environment, with the parameters being merely exemplary.

It will be understood that the number of outputs of the feed network units 131, 132 depends on the number of radiating elements in the row of radiating elements. In an example as shown in FIG. 7, the radiating element array 120 may comprise a first row of radiating elements and a second row of radiating elements, where the first row of radiating elements may have three radiating elements, and the second row of radiating elements may have four radiating elements. At this point, a two-input three-output feed network unit as shown in FIG. 13 may be employed for the first row of radiating elements, and a two-input four-output feed network unit as shown in FIG. 14 may be employed for the second row of radiating elements.

In view of the compact dimension of the feed network units, the first feed network unit 131 and the second feed network unit 132 of the feed network module for a row of radiating elements may be arranged side by side with each other. As shown in FIG. 12, a first feed network unit 131 may be implemented on a first printed circuit board, and a second feed network unit 132 may be implemented on a second printed circuit board, wherein the first printed circuit board and the second printed circuit board are arranged side by side with each other in the horizontal direction H. The first printed circuit board and the second printed circuit board may be integrated, for example, on one support plate.

With continued reference to FIG. 8 to FIG. 11, the coupler 10 in the feed network units 131, 132 according to some examples of the present application is introduced in detail. The coupler 10 may comprise a dielectric substrate 11, a first transmission line 21 and a second transmission line 22 provided on a first side (i.e., front side) of the dielectric substrate 11, and a first coupling line 31 and a second coupling line 32 provided on a second side (i.e., rear side) of the dielectric substrate 11. The first transmission line 21 may be electrically connected between an input end and an output end of the coupler 10, and the second transmission line 22 may be electrically connected between a coupling end and an isolation end of the coupler 10. It will be understood that according to the principle of interoperability, the input end and the output end as well as the coupling end and the isolation end of the coupler 10 may be adjusted according to the input position of the radio frequency signals.

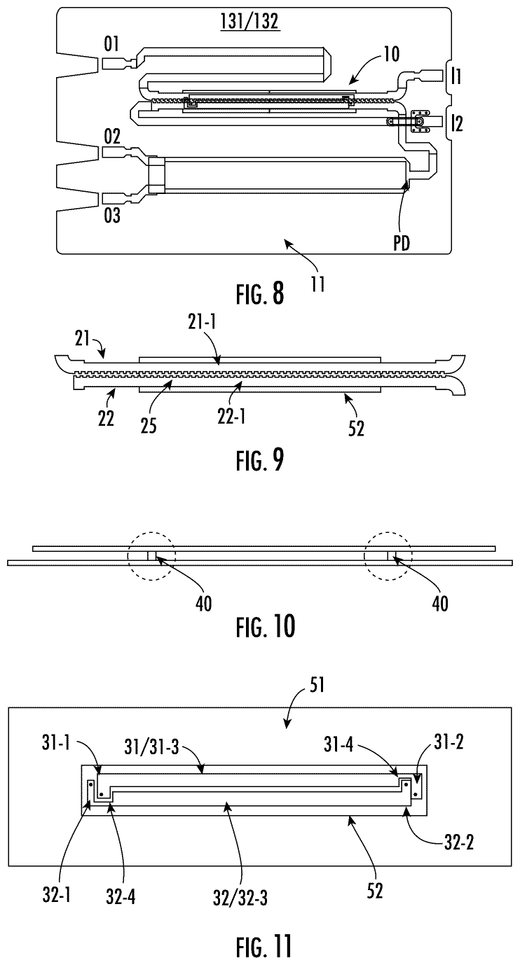

As shown in FIG. 11, a grounded metal area 51 and an isolation area 52 may be provided on the second side (i.e., rear side) of the dielectric substrate 11. The first coupling line 31 and the second coupling line 32 may be disposed within the isolation area 52 and electrically isolated from the grounded metal area 51 via the isolation area 52. The so-called isolation area 52 may be understood as having no metal coating or as having removed an area of the metal coating. As shown in FIG. 9, the isolation area 52 may be, for example, in an intermediate area of the coupler 10. In some examples, a width of the isolation area 52 may be slightly wider than a width of the first transmission line 21 along with the second transmission line 22 at the intermediate area, i.e., the projection of the first transmission line 21 along with the second transmission line 22 on the intermediate area may fall into the isolation area 52.

To enable the parallel line coupler 10 to achieve the desired coupling degree, the coupler 10 of the feed network unit of the present application incorporates different coupling manners. In particular, these coupling methods may involve side coupling or parallel coupling between transmission lines, side coupling or parallel coupling between coupling lines, and up and down coupling between the coupling lines and the transmission lines.

To achieve the above-mentioned coupling manners, the first coupling line 31 and the first transmission line 21 may be provided on two sides of the dielectric substrate 11 in a mode of at least partially overlapping with each other, and the second coupling line 32 and the second transmission line 22 may be provided on two sides of the dielectric substrate 11 in a mode of at least partially overlapping with each other.

In some examples, a coupling section 31-3 of the first coupling line 31 and the first transmission line 21 may substantially overlap each other, and a coupling section 32-3 of the second coupling line 32 and the second transmission line 22 may substantially overlap each other. The so-called substantial overlap may be understood as the projections of the coupling sections of the coupling lines on the forward projected surfaces substantially fall within the projected surfaces of the respective transmission lines completely. The so-called partial overlap may be understood as the projections of the coupling sections of the coupling lines on the forward projected surfaces substantially fall within the projected surfaces of the respective transmission lines partially.

In some examples, a coupling section 31-3 of the first coupling line 31 and a coupling section 21-1 of the first transmission line 21 may extend substantially parallel to each other, and a coupling section 32-3 of the second coupling line 32 and a coupling section 22-1 of the second transmission line 22 may extend substantially parallel to each other.

In some examples, lengths of the first coupling line 31 and the second coupling line 32 may be between 0.2 to 0.05 times the electromagnetic wave air wavelength corresponding to a central frequency of an operating frequency band of the coupler 10, respectively. In some examples, the lengths of the first coupling line 31 and the second coupling line 32 may be substantially equal to 0.1 times the electromagnetic wave air wavelength corresponding to the central frequency of the operating frequency band of the coupler 10, respectively. In some examples, a length of a coupling section 31-3 of the first coupling line 31 is less than a length of the coupling section 21-1 of the first transmission line 21, and the length of a coupling section 32-3 of the second coupling line 32 is less than a length of the coupling section 22-1 of the second transmission line 22. In some examples, the length of the coupling section 31-3 of the first coupling line 31 is greater than 50% of the length of the coupling section 21-1 of the first transmission line 21, and the length of the coupling section 32-3 of the second coupling line 32 is greater than 50% of the length of the coupling section 22-1 of the second transmission line 22. In some examples, the width of the coupling section 31-3 of the first coupling line 31 is substantially equal to the width of the coupling section 21-1 of the first transmission line 21, and the width of the coupling section 32-3 of the second coupling line 32 is substantially equal to the width of the coupling section 22-1 of the second transmission line 22.

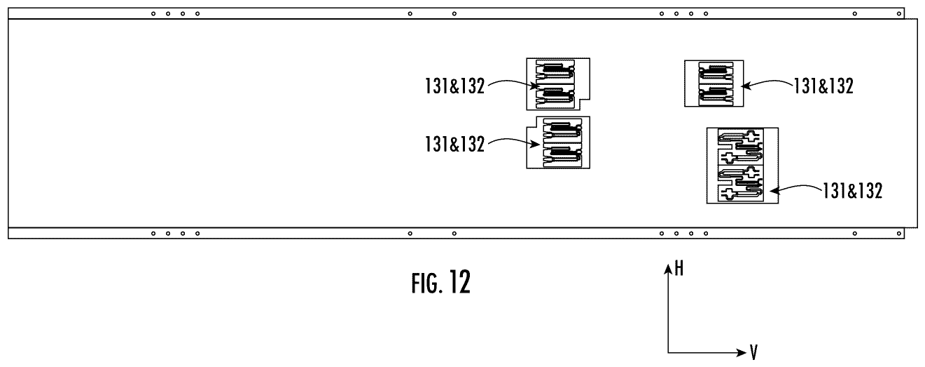

Advantageously, as shown in FIG. 10, the first coupling line 31 may be electrically connected to the second transmission line 22 via conductive structures 40, such as metalized via holes, respectively, and the second coupling line 32 may be electrically connected to the first transmission line 21 via conductive structures 40, such as metalized via holes, respectively. The respective conductive structures 40, such as the metalized via holes, may pass through the dielectric substrate 11 and are electrically connected with the respective transmission lines and coupling lines on two sides, respectively. Such interleaved connection between the coupling lines and the transmission lines may facilitate a strong coupling degree of the coupler 10.

The first coupling line 31 may comprise two connection parts 31-1, 31-2 and the coupling section 31-3 may be located therebetween, and the second coupling line 32 may comprise two connection parts 32-1, 32-2 and the coupling section 32-3 may be located therebetween. The connection parts 31-1, 31-2 of the first coupling line 31 may be electrically connected to the second transmission line 22 via the conductive structures 40, respectively, and the connection parts 32-1, 32-2 of the second coupling line 32 may be electrically connected to the first transmission line 21 via the conductive structures 40, respectively.

To achieve the desired coupling between the first and second coupling lines 32, the coupling section 31-3 of the first coupling line 31 and the coupling section 32-3 of the second coupling line 32 may be arranged substantially parallel to each other and spaced apart from each other. Further, the connection parts between the two coupling lines may be arranged in stagger. Such staggered arrangement may facilitate a desired coupling degree of the coupler 10. As shown in FIG. 11, such staggered arrangement may be achieved by the following manner: The second coupling line 32 may have a first depression part 32-4 disposed adjacent to a first connection part 32-1 of the second coupling line, the first connection part 31-1 of the first coupling line 31 may extend towards the second coupling line 32 into the first depression part 32-4; and the first coupling line 31 may have a second depression part 31-4 disposed adjacent to a second connection part 31-2 of the first coupling line, the second connection part 32-2 extends towards the first coupling line 31 into the second depression part 31-4. The first and second connection parts 31-1, 31-2 of the first coupling line 31 may extend further towards the second coupling line 32 relative to the coupling section of the first coupling line, and the first and second connection parts 32-1, 32-2 of the second coupling line 32 may extend further towards the first coupling line 31 relative to the coupling section of the second coupling line. In some examples, the first and second connection parts 31-1, 31-2 of the first coupling line 31 may extend substantially vertically, for example, relative to the coupling section of the first coupling line, and the first and second connection parts 32-1, 32-2 of the second coupling line 32 may extend substantially vertically, for example, relative to the coupling section of the second coupling line.

As the first depression part 32-4 is adjacent the first connection part 32-1 of the second coupling line 32, the first connection part 31-1 of the first coupling line 31 may therefore be arranged closely to each other with the first connection part 32-1 of the second coupling line 32, and the gap therebetween is for example less than 2 millimeters, 1 millimeter, 0.5 millimeters, 0.2 millimeters, or 0.1 millimeters. Similarly, as the second depression part 31-4 is adjacent the second connection part 31-2 of the first coupling line 31, the second connection part 31-2 of the first coupling line 31 may therefore be arranged closely to each other with the second connection part 32-2 of the second coupling line 32, and the gap therebetween is for example less than 2 millimeters, 1 millimeter, 0.5 millimeters, 0.2 millimeters, or 0.1 millimeters. This improves the desired coupling between the first and second coupling lines 32.

In some examples, the first connection part 31-1 of the first coupling line 31 and the first connection part 32-1 of the second coupling line 32 are arranged substantially parallel to each other and spaced apart from each other; and the second connection part 31-2 of the first coupling line 31 and the second connection part 32-2 of the second coupling line 32 are arranged substantially parallel to each other and spaced apart from each other.

In some examples, to further improve the coupling performance of the coupler 10, at least one of the coupling section 21-1 of the first transmission line 21 and the coupling section 22-1 of the second transmission line 22 may have a varying edge profile 25, such that a varying gap is formed between the two coupling sections of the first transmission line 21 and the second transmission line 22. At least one of the coupling section 21-1 of the first transmission line 21 and the coupling section 22-1 of the second transmission line 22 has a periodically-varied edge profile 25, such that a periodically-varied gap is formed between the two coupling sections of the first transmission line 21 and the second transmission line 22. In some examples, the spacing between the depression parts of the opposing edge profiles 25 may be between 2 millimeters and 0.55 millimeters, and the spacing between the non-depression parts of the opposing edge profiles 25 may be between 0.45 millimeters and 0.2 or 0.1 millimeters. It will be understood that respective spacing is exemplary and not non-limiting. Depending on the application scene, the respective spacing may be adaptively adjusted.

In some examples, as shown in FIG. 8 and FIG. 9, the coupling section 21-1 of the first transmission line 21 and the coupling section 22-1 of the second transmission line 22 may have a serrated edge profile 25, respectively. In other examples, the coupling section 21-1 of the first transmission line 21 and the coupling section 22-1 of the second transmission line 22 may have a wavy edge profile 25, respectively. It will be understood that the shape of the respective edge profile 25 is exemplary and non-limiting. The shape of the respective edge profile 25 may be adaptively adjusted according to different applications. In some examples, a first section of the edge profile 25 may be formed as a first edge profile 25, while a second section of the edge profile 25 may be formed as a second edge profile 25, where the first edge profile 25 and the second edge profile 25 are different in shape and/or dimension.

It will be understood that the coupler 10 of the present application may also be applied to other RF network systems of the antenna. In some examples, the RF network system may be formed as a calibration network for an antenna, the calibration network may be used for identifying any undesirable change in an amplitude and/or phase of RF signals input to different RF ports of the antenna. The calibration network may generally have a power divider and a coupler 10 according to embodiments of the present invention.

Although some specific examples of the present application have been described in detail through examples, those skilled in the art should understand that the above examples are only for illustration rather than for limiting the scope of the present application. Various examples disclosed herein can be combined arbitrarily without departing from the spirit and scope of the present disclosure. Those skilled in the art should also understand that various modifications may be made to the examples without departing from the scope and spirit of the present disclosure. The scope of the present application is defined by the attached claims.

1. A coupler, comprising:
a dielectric substrate;
a first transmission line and a second transmission line on a first side of the dielectric substrate; and
a first coupling line and a second coupling line on a second side of the dielectric substrate,
wherein the first coupling line and the first transmission line at least partially overlap each other in a first direction that is perpendicular to a first side of the dielectric substrate, and the second coupling line and the second transmission line at least partially overlap each other in the first direction,
wherein the first coupling line is electrically connected to the second transmission line via one or more first conductive structures, and the second coupling line is electrically connected to the first transmission line via one or more second conductive structures.

2. The coupler according to claim 1, wherein the second side of the dielectric substrate includes a grounded metal area and an isolation area, and the first coupling line and the second coupling line are within the isolation area and are electrically isolated from the grounded metal area via the isolation area.

3. The coupler according to claim 2, wherein the isolation area comprises a region on the second side of the dielectric substrate that is devoid of a metal coating.

4. The coupler according to claim 1, wherein the first conductive structures and the second conductive structures each comprise metalized via holes that pass through the dielectric substrate and are electrically connected with respective transmission lines and coupling lines on the respective first and second sides of the dielectric substrate.

5. The coupler according to claim 1, wherein the first coupling line comprises first and second connection parts and a coupling section located therebetween, the second coupling line comprises third and fourth connection parts and a coupling section located therebetween, wherein the first and second connection parts of the first coupling line are electrically connected with the second transmission line via a pair of first conductive structures, respectively, and the third and fourth connection parts of the second coupling line are electrically connected with the first transmission line via a pair of second conductive structures, respectively.

6. The coupler according to claim 5, wherein the coupling section of the first coupling line and the coupling section of the second coupling line are arranged substantially parallel to each other and spaced apart from each other.

7. The coupler according to claim 5, wherein the coupling section of the first coupling line and the first transmission line substantially overlap each other in the first direction, and the coupling section of the second coupling line and the second transmission line substantially overlap each other in the first direction.

8. The coupler according to claim 5, wherein
the second coupling line has a first depression part disposed adjacent a first connection part of the second coupling line, and a first connection part of the first coupling line extends towards the second coupling line into the first depression part;
the first coupling line has a second depression part disposed adjacent a second connection part of the first coupling line, and a second connection part of the second coupling line extends towards the first coupling line into the second depression part;
the first connection part and the second connection part of the first coupling line extend further towards the second coupling line relative to the coupling section of the first coupling line, and the first connection part and the second connection part of the second coupling line extend further towards the first coupling line relative to the coupling section of the second coupling line.

9. The coupler according to claim 8, wherein
the first connection part of the first coupling line and the first connection part of the second coupling line are arranged closely to each other, and the gap therebetween is less than 1 millimeter; and
the second connection part of the first coupling line and the second connection part of the second coupling line are arranged closely to each other, and the gap therebetween is less than 1 millimeter.

10. The coupler according to claim 8, wherein the first connection part of the first coupling line and a first connection part of the second coupling line are arranged substantially parallel to each other and spaced apart from each other; and
the second connection part of the first coupling line and the second connection part of the second coupling line are arranged substantially parallel to each other and spaced apart from each other.

11. The coupler according to claim 5, wherein the first and second connection parts of the first coupling line is substantially perpendicular to the coupling section of the first coupling line, and the first and second connection parts of the second coupling line is substantially perpendicular to the coupling section of the second coupling line.

12. The coupler according to claim 1, wherein at least one of the coupling section of the first transmission line and the coupling section of the second transmission line has a varying edge profile, such that a varying gap is formed between the two coupling sections of the first transmission line and the second transmission line.

13. The coupler according to claim 12, wherein at least one of the coupling section of the first transmission line and the coupling section of the second transmission line has a periodically-varied edge profile, such that a periodically-varied gap is formed between the two coupling sections of the first transmission line and the second transmission line.

14. The coupler according to claim 12, wherein at least one of the coupling section of the first transmission line and the coupling section of the second transmission line has a serrated edge profile or a wavy edge profile.

15. The coupler according to claim 1, wherein the coupling section of the first transmission line and the coupling section of the second transmission line extend substantially parallel to each other.

16. The coupler according to claim 5, wherein the coupling section of the first coupling line and the first transmission line extend substantially parallel to each other, and the coupling section of the second coupling line and the second transmission line extend substantially parallel to each other.

17. The coupler according to claim 5, wherein a length of the coupling section of the first coupling line is less than a length of the coupling section of the first transmission line, and a length of the coupling section of the second coupling line is less than a length of the coupling section of the second transmission line.

18. The coupler according to claim 17, wherein the length of the coupling section of the first coupling line is greater than 50% of a length of the coupling section of the first transmission line, and the length of the coupling section of the second coupling line is greater than 50% of a length of the coupling section of the second transmission line.

19. The coupler according to claim 5, wherein a width of the coupling section of the first coupling line is substantially equal to a width of the coupling section of the first transmission line, and a width of the coupling section of the second coupling line is substantially equal to a width of the coupling section of the second transmission line.

20. The coupler according to claim 5, wherein lengths of the first coupling line and the second coupling line are between 0.2 to 0.05 times an electromagnetic wave air wavelength corresponding to a central frequency of an operating frequency band of the coupler, respectively.

21-34. (canceled)
